(19) United States
(12) Patent Application Publication
(10) Pub. No.: US 2017/0018857 A1
(43) Pub. Date: Jan. 19, 2017

(54) DUAL-BAND ANTENNA

(71) Applicant: Arcadyan Technology Corporation, Hsinchu City (TW)

(72) Inventors: Kuo-Chang LO, Miaoli County (TW); Chih-Yung HUANG, Taichung City (TW)

(73) Assignee: Arcadyan Technology Corporation, Hsinchu City (TW)

(21) Appl. No.: 15/174,484

(22) Filed: Jun. 6, 2016

(30) Foreign Application Priority Data
Jul. 14, 2015 (TW) 104122717

(51) Int. Cl. H01Q 21/30; H01Q 9/04

(52) U.S. Cl. CPC H01Q 21/30; H01Q 9/0407

(57) ABSTRACT

A dual-band antenna including a first radiation part and a second radiation part is provided. The first radiation part is arranged along a first direction. One end of the first radiation part includes a first feeding part. The other end of the first radiation part extends along a second direction and accordingly forms a first bending part. The second radiation part is arranged along the first direction. One end of the second radiation part includes a second feeding part. The projection of the one end of the second radiation part in the second direction is partially overlapped with the first radiation part. The second feeding part and the first feeding part are separated by a first gap. The first bending part and the second radiation part are separated by a second gap which is different from the first gap.

This application claims the benefit of Taiwan application Serial No. 104122717, filed Jul. 14, 2015, the disclosure of which is incorporated by reference herein in its entirety.

### TECHNICAL FIELD

The disclosure relates in general to an antenna device and more particularly to a dual-band antenna.

### BACKGROUND

In recent years, along with the development in communication technology, various electronic products, such as notebook computer, mobile phone and access point (AP), are equipped with the function of wireless transmission.

Conventionally, various antennas, such as planar inverse-F antenna (PIFA) and monopole antenna dipole antenna, are widely used in electronic devices, notebook computers or wireless communication devices. Since most electronic products need to correspond to the communication protocols of different bands, conventional architecture of antenna is applicable to one single band cannot support multi-band wireless communication. Besides, in response to the thinning trend of electronic products, the structural design of some antennas is also restricted.

Therefore, how to provide a dual-band antenna configured with simple structure whose frequency of resonant mode can be easily adjusted according to product needs has become a prominent task for the industries.

### SUMMARY

The disclosure is directed to a dual-band antenna configured with simple structure whose frequency of resonant mode can be easily adjusted.

According to one embodiment, a dual-band antenna including a first radiation part and a second radiation part is provided. The first radiation part is arranged along a first direction. One end of the first radiation part includes a first feeding part. The other end of the first radiation part extends along a second direction and accordingly forms a first bending part. The second radiation part is arranged along the first direction. One end of the second radiation part includes a second feeding part disposed adjacent to the first feeding part. The projection of the one end of the second radiation part in the second direction is partially overlapped with the first radiation part. The second feeding part and the first feeding part are separated by a first gap. The first bending part and the second radiation part are separated by a second gap which is different from the first gap.

According to another embodiment, a dual-band antenna including a first radiation part and a second radiation part is provided. The first radiation part is arranged along a first direction. One end of the first radiation part includes a first feeding part. The other end of the first radiation part extends along a second direction and accordingly forms a first bending part. The second radiation part is arranged along the first direction. One end of the second radiation part includes a second feeding part disposed adjacent to the first feeding part. The projection of the one end of the second radiation part in the second direction is partially overlapped with the first radiation part. The second feeding part and the first feeding part are separated by a first gap. The first bending part and the second radiation part are separated by a second gap which is different from the first gap. One side of the second radiation part includes a metal patch extending along an inverse direction of the second direction and separated from the first feeding part by a third gap. At least two of the first gap, the second gap and the third gap are different from each other.

According to an alternative embodiment, a dual-band antenna including a first radiation part and a second radiation part is provided. The first radiation part is arranged along a first direction. One end of the first radiation part includes a first feeding part. The other end of the first radiation part extends along a second direction and accordingly forms a first bending part. The second radiation part is arranged along the first direction. One end of the second radiation part includes a second feeding part disposed adjacent to the first feeding part. The projection of the one end of the second radiation part in the second direction is partially overlapped with the first radiation part. The second feeding part and the first feeding part are separated by a first gap. The first bending part and the second radiation part are separated by a second gap which is different from the first gap. The other end of the second radiation part extends along an inverse direction of the second direction and further extends towards the first radiation part to form a second bending part. The terminal end of the second bending part and the first radiation part are separated by a third gap. At least two of the first gap, the second gap and the third gap are different from each other.

According to another alternate embodiment, a dual-band antenna including a first radiation part and a second radiation part is provided. One end of the first radiation part includes a first feeding part. The other end of the first radiation part extends along a second direction and accordingly forms a first bending part. The second radiation part is arranged along the first direction. One end of the second radiation part includes a second feeding part disposed adjacent to the first feeding part. The projection of the one end of the second radiation part in the second direction is partially overlapped with the first radiation part. The second feeding part and the first feeding part are separated by a first gap. The terminal end of the first bending part of the first radiation part extends towards the second radiation part and is separated from the second radiation part by a second gap which is different from the first gap.

According to another alternate embodiment, a dual-band antenna including a first radiation part and a second radiation part is provided. The first radiation part is arranged along a first direction. One end of the first radiation part extends along a second direction and accordingly forms a first bending part. The first direction and the second direction are orthogonal to each other. The second radiation part is arranged along the first direction. The projection of the one end of the second radiation part in the second direction is partially overlapped with the first radiation part.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of a dual-band antenna according to an embodiment of the invention.

FIG. 2 is a schematic diagram of a dual-band antenna according to another embodiment of the invention.

FIG. 3 is a schematic diagram of a dual-band antenna according to an alternate embodiment of the invention.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The embodiments of the invention are disclosed below with accompanying drawings. Apart from the disclosed embodiments, the invention can further be implemented in other embodiments. Any simple replacements, modifications, or equivalent variations of the disclosed embodiments are within the scope of protection of the invention. In the specification of the invention, many specific details are provided for the readers to obtain better and more thorough understanding of the invention. However, the invention still can be implemented under the circumstances that some or all of the specific details are omitted. Besides, generally-known steps or elements are not described in the details of the invention to avoid adding unnecessary restrictions to the invention. Common or similar elements of the drawings are represented with common or similar designations. It should be noted that the drawings are for schematic and exemplary purposes only, not for limiting the actual sizes or quantities of the elements unless specific descriptions are given.

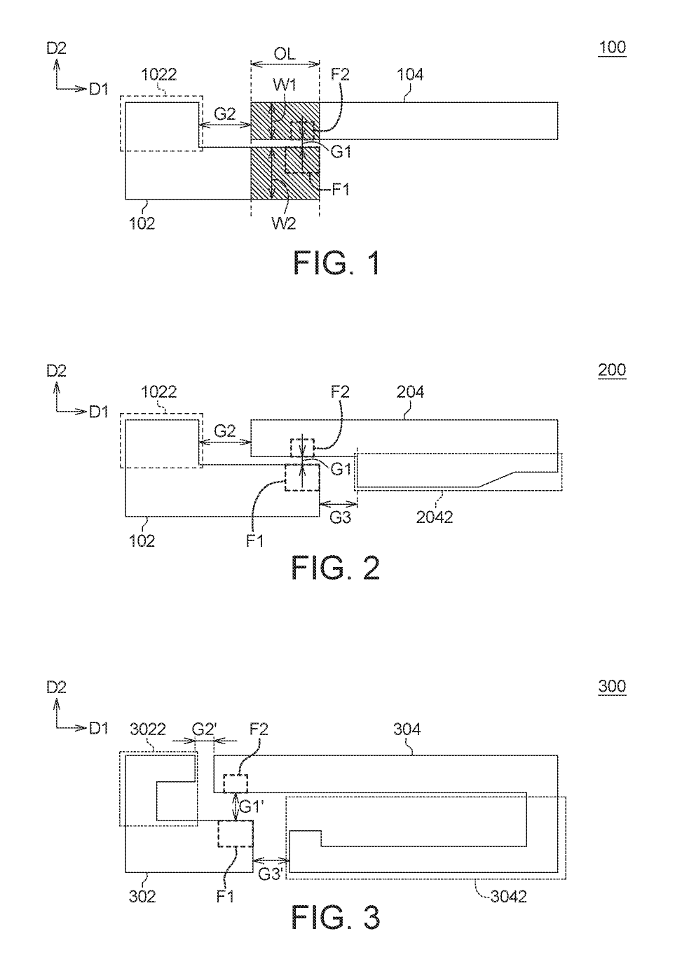

FIG. 1 is a schematic diagram of a dual-band antenna 100 according to an embodiment of the invention. The dual-band antenna 100 mainly includes a first radiation part 102 and a second radiation part 104. The dual-band antenna 100 is, for example, printed on a substrate (not illustrated). The first radiation part 102 and the second radiation part 104 are, for example, printed on the same side of the substrate. The first radiation part 102 and the second radiation part 104 are two separate metal patterns used as two radiation branches under the architecture of dipole antenna. According to the embodiments of the invention, the first radiation part 102 and the second radiation part 104 are two complete metal sheets free of slots and/or slits.

The first radiation part 102 is arranged along the first direction D1. One end of the first radiation part 102 includes a first feeding part F1, and the other end of the first radiation part 102 extends along the second direction D2 and accordingly forms a first bending part 1022. In the present exemplary embodiment, the first direction D1 and the second direction D2 substantially are orthogonal to each other. Therefore, the first radiation part 102 is an approximately L-shaped metal pattern. In some embodiments, the first direction D1 and the second direction D2 are not parallel to each other, and the first radiation part 102 is operated in a first band.

The second radiation part 104 is also arranged along the first direction D1. The second radiation part 104 and the first radiation part 102 are not arranged on the same dummy line in a head to head manner. Instead, the second radiation part 104 and the first radiation part 102 are arranged on two parallel dummy lines in a staggered manner. As indicated in FIG. 1, one end of the second radiation part 104 includes a second feeding part F2; the second feeding part F2 is disposed adjacent to the first feeding part F1; the projection of the one end of the second radiation part 104 in the second direction D2 is partially overlapped with the first radiation part 102 (as indicated in the hatched area, the length of the overlapped portion, that is, the projection length, is designated by “OL”); the second radiation part 104 is operated in a second band. According to an embodiment of the invention, the width W1 of one end of the first radiation part 102 including the first feeding part F1 is different from the width W2 of one end of the second radiation part 104 including the second feeding part F2. As indicated in FIG. 1, the width W1 is smaller than the width W2.

The first feeding part F1 and the second feeding part F2 receive radio frequency (RF) signals from signal transmission lines (not illustrated). For example, the earth wire and the fire wire of the signal transmission lines can be connected to the first feeding part F1 and the second feeding part F2 for feeding the RF signals to the dual-band antenna 100. The second feeding part F2 and the first feeding part F1 are, for example, separated by a first gap G1.

In the present exemplary embodiment, the first bending part 1022 and the second radiation part 104 are separated by a second gap G2. The second gap G2 is, for example, greater than the first gap G1, and by adjusting the size of the second gap G2, the operating frequency and bandwidth of the first band can be adjusted accordingly.

FIG. 2 is a schematic diagram of a dual-band antenna 200 according to another embodiment of the invention. The dual-band antenna 200 and the dual-band antenna 100 are similar except that the dual-band antenna 200 additionally includes a metal patch 2042. As indicated in FIG. 2, one side of the second radiation part 204 of the dual-band antenna 200 includes a metal patch 2042, which extends along an inverse direction of the second direction D2 (towards the bottom of the diagram). It can be understood that the pattern of the metal patch 2042 is not limited to that illustrated in FIG. 2. The metal patch 2042 of the present embodiment can be realized by any metal pattern protruded outwards from one side of the second radiation part 204. For example, the width of the metal patch 2042 can gradually reduce towards one end of the second radiation part 204 as indicated in FIG. 2 or reduce in a stepped manner. Or, the metal patch 2042 can have a specific pattern, such as rectangle, trapezoid, or triangle. The metal patch 2042 can increase the current path formed on the second radiation part 204 to increase the operating bandwidth of the antenna. Besides, the metal patch 2042 can also be used as a design factor for the impedance matching of the antenna.

In the present exemplary embodiment, the metal patch 2042 and the first radiation part 102 are separated by a third gap G3. By adjusting the size of the third gap G3, the operating frequency and bandwidth of the second band can be adjusted accordingly. At least two of the first gap G1, the second gap G2 and the third gap G3 are different from each other. For example, the third gap G3 is greater than the first gap G1.

FIG. 3 is a schematic diagram of a dual-band antenna according to an alternate 300 embodiment of the invention. The dual-band antenna 300 and the dual-band antenna 100 are similar except that the first radiation part 302 of the dual-band antenna 300 includes a first bending part 3022, and the second radiation part 304 includes a second bending part 3042. As indicated in FIG. 3, after one end of the first radiation part 302 extends along the second direction D2, the terminal end of the first radiation part 302 extends towards the second radiation part 304 to form a first bending part 3022. Therefore, the first radiation part 302 is a U-shaped metal pattern. The first bending part 3022 and the second radiation part 304 are separated by a second gap G2′.

On the other end, after one end of the second radiation part 304 extends along an inverse direction of the second direction D2 (towards the bottom of the diagram), the terminal end of the second direction D2 extends towards the first radiation part 304 to form a second bending part 3042. Wherein, the terminal end of the second bending part 3042 and the first radiation part 302 are separated by a third gap G3′.

Like the previous embodiment, one end of the first radiation part 302 including the first feeding part F1′ is at least overlapped with one end of the second radiation part 304 including the second feeding part F2′. The first feeding part F1′ and the second feeding part F2′ are separated by a first gap G1′, At least two of the first gap G1′, the second gap G2′ and the third gap G3′ are different from each other.

It should be noted that the dual-band antennas 100, 200, and 300 disclosed in the embodiments of the invention can have different variations by way of combining or replacing parts of the structure. For example, the first bending part 1022 of the dual-band antennas 100 and 200 can exchange with the first bending part 3022 of the dual-band antenna 300; the metal patch 2042 of the dual-band antenna 200 and the second bending part 3042 of the dual-band antenna 300 are exchangeable; the dual-band antenna 100 can selectively include the second bending part 3042 of the dual-band antenna 300. All the said variations are within the spirit of the invention.

To summarize, based on the architecture of dipole antenna, the projection of two radiation branches of the dual-band antenna of the invention is partly overlapped to excite another resonant mode, such that the antenna can perform dual-band operation. The designer of antenna can adjust the operating frequency of the antenna by changing the length of projection of the overlapped portion and/or the structure of the radiation branches. Besides, the dual-band antenna of the invention has the advantages of simple structure and lightweight of dipole antenna, and can be integrated with various communication electronic products according to actual needs.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A dual-band antenna, comprising:
a first radiation part arranged along a first direction, wherein one end of the first radiation part comprises a first feeding part, and the other end of the first radiation part extends along a second direction and accordingly forms a first bending part; and
a second radiation part arranged along a first direction, wherein one end of the second radiation part comprises a second feeding part, the projection of the one end of the second radiation part in the second direction is partially overlapped with the first radiation part, the second feeding part and the first feeding part are separated by a first gap, and the first bending part and the second radiation part are separated by a second gap which is different from the first gap.

2. The dual-band antenna according to claim 1, wherein one side of the second radiation part comprises a metal patch extending along an inverse direction of the second direction and separated from the first radiation part by a third gap.

3. The dual-band antenna according to claim 1, wherein the other end of the second radiation part extends along an inverse direction of the second direction and further extends towards the first radiation part to form a second bending part, and the terminal end of the second bending part and the first radiation part are separated by a third gap.

4. The dual-band antenna according to claim 1, wherein the terminal end of the first bending part extends towards the second radiation part and the second radiation part are separated by the second gap.

5. The dual-band antenna according to claim 1, wherein the second gap is greater than the first gap.

6. The dual-band antenna according to claim 2, wherein at least two of the first gap, the second gap and the third gap are different from each other.

7. The dual-band antenna according to claim 3, wherein at least two of the first gap, the second gap and the third gap are different from each other.

8. The dual-band antenna according to claim 1, wherein the first direction and the second direction are orthogonal to each other.

9. A dual-band antenna, comprising:
a first radiation part arranged along a first direction, wherein one end of the first radiation part extends along a second direction and accordingly forms a first bending part, and the first direction and the second direction are orthogonal to each other; and
a second radiation part arranged along a first direction, wherein the projection of the one end of the second radiation part in the second direction is partially overlapped with the first radiation part.

10. The dual-band antenna according to claim 9, wherein one side of the second radiation part comprises a metal patch extending along an inverse direction of the second direction.

11. The dual-band antenna according to claim 9, wherein the other end of the second radiation part extends along an inverse direction of the second direction and further extends towards the first radiation part to form a second bending part.

12. The dual-band antenna according to claim 11, wherein the terminal end of the first bending part extends towards the second radiation part and is separated from the second radiation part by a gap.
